(19) United States
(12) Patent Application Publication
(10) Pub. No.: US 2002/0163580 A1
(43) Pub. Date: Nov. 7, 2002

(54) Image pickup apparatus, cartridge locking apparatus, and cartridge locking method

(75) Inventor: Hiroyuki Hase, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/126,684

(22) Filed: Apr. 22, 2002

(30) Foreign Application Priority Data
May 7, 2001 (JP) 136271/2001

(51) Int. Cl. H04N 5/225

(52) U.S. Cl. 348/207.2

(57) ABSTRACT

In an image pickup apparatus, a cartridge locking apparatus and a cartridge locking method, a cartridge, accommodating a recording medium for printing, mounted in a mounting unit for mounting the cartridge is locked so as not to be detached in response to a state a printing operation is being performed.

### BACKGROUND OF THE INVENTION

1. Field of the Invention

The present invention relates to an image pickup apparatus, a cartridge locking apparatus, and a cartridge locking method, in which a cartridge accommodating a recording medium for printing is locked so as not to be detached.

2. Description of the Related Art

Conventionally, there exist cameras, each including a printer, having a printing function as well as a photographing function. In such cameras, a cartridge accommodating recording paper can be detachably loaded in the main body of the camera. A technique relating to a locking apparatus for fixing a cartridge accommodating recording paper when loading the cartridge into the main body of a camera is disclosed, for example, in Japanese Patent Application Laid-Open (Kokai) No. 11-208902 (1999). In the conventional technique described in this patent application, when a cartridge accommodating recording paper is loaded into the main body of a camera, the cartridge is locked in the main body of the camera by a locking arm. When taking the cartridge out of the main body of the camera, the locking of the cartridge is released by driving the locking arm by operating a locking releasing button, and the cartridge is pushed out from the main body of the camera by the force of a spring.

However, the above-described conventional approach has the following problems. That is, in the above-described conventional camera including the printer, if the locking releasing button is carelessly operated during a printing operation, the locking arm is driven to release the locking of the cartridge. As a result, the cartridge loaded in the main body of the camera is pushed out by the force of the spring, thereby influencing the printing operation to cause a failure in the obtained print.

### SUMMARY OF THE INVENTION

It is an object of the present invention to provide an image pickup apparatus, a cartridge locking apparatus and a cartridge locking method in which careless taking-out of a cartridge during a printing operation can be assuredly prevented.

According to one aspect, the present invention which achieves the above-described object relates to an image pickup apparatus having a function for printing a sensed image. The apparatus includes a mounting unit that mounts a cartridge accommodating a recording medium for printing, and a locking device that locks the cartridge mounted in the mounting unit so as not to be detached in response to a state in which a printing operation is being performed.

According to another aspect, the present invention which achieves the above-described object relates to a cartridge locking method for an image pickup apparatus having a function for printing a sensed image. The method includes the step of locking a cartridge, accommodating a recording medium for printing, mounted in a mounting unit for mounting the cartridge so as not to be detached, in response to a state in which a printing operation is being performed.

According to still another aspect, the present invention which achieves the above-described object relates to a cartridge locking apparatus including a mounting unit that mounts a cartridge accommodating a recording medium for printing, and a locking device that locks the cartridge mounted in the mounting unit so as not to be detached, in response to a state in which a printing operation is being performed.

According to yet another aspect, the present invention which achieves the above-described object relates to a cartridge locking method including the step of locking a cartridge, accommodating a recording medium for printing, mounted in a mounting unit for mounting the cartridge so as not to be detached in response to a state in which a printing operation is being performed.

The foregoing and other objects, advantages and features of the present invention will become more apparent from the following detailed description of the preferred embodiments taken in conjunction with the accompanying drawings.

### BRIEF DESCRIPTION OF THE DRAWINGS

FIG. 1 is a perspective view, as seen from a front right side, illustrating an external appearance of a camera including a printer, according to a first embodiment of the present invention;

FIG. 2 is a perspective view, as seen from a rear right side, illustrating an external appearance of the camera shown in FIG. 1;

FIG. 3 is an exploded perspective view illustrating the configurations of opening/closing of a discharge port and an insertion port of the camera shown in FIG. 1;

FIG. 4 is a perspective view illustrating an external appearance of a cartridge of the camera shown in FIG. 1;

FIG. 5 is an exploded perspective view illustrating the configurations of cartridge locking, recording-head driving, and sheet feeding in the camera shown in FIG. 1;

FIG. 6 is a lateral cross-sectional view illustrating a state in which the cartridge is taken out of a cartridge accommodating chamber in the camera shown in FIG. 1;

FIG. 7 is a lateral cross-sectional view illustrating a state in which the cartridge is accommodated within the cartridge accommodating chamber in the camera shown in FIG. 1;

FIG. 8 is a lateral cross-sectional view illustrating a state before recording paper is fed in the state shown in FIG. 7;

FIG. 9 is a lateral cross-sectional view illustrating a state in which recording paper is fed and the cartridge is locked in the camera shown in FIG. 1;

FIG. 10 is a lateral cross-sectional view illustrating a state in which printed recording paper is discharged outside of a cover in the camera shown in FIG. 1;

FIG. 11 is a block diagram illustrating the functions of the camera shown in FIG. 1;

FIGS. 12 and 13 are flowcharts, each illustrating an operation procedure of the camera shown in FIG. 1;

FIG. 14 is a perspective view, as seen from a rear right side, illustrating an external appearance of a camera including a printer, according to a second embodiment of the present invention;

FIG. 15 is an exploded perspective view illustrating the configuration of a locking-release button in the camera shown in FIG. 14;

FIG. 16 is a perspective view illustrating an external appearance of a cartridge of the camera shown in FIG. 14;

FIG. 17 is an exploded perspective view illustrating the configuration of a locking-release lever, recording-head driving, and sheet feeding in the camera shown in FIG. 14;

FIG. 18 is a lateral cross-sectional view illustrating a state in which the cartridge is taken out of a cartridge accommodating chamber in the camera shown in FIG. 14;

FIG. 19 is a lateral cross-sectional view illustrating a state in which the cartridge is loaded within the cartridge accommodating chamber in the camera shown in FIG. 14;

FIG. 20 is a perspective view of a surrounding portion of the locking-release button, illustrating a state in which the cartridge is locked in the camera shown in FIG. 14;

FIG. 21 is a perspective view of the surrounding portion of the locking-release button, illustrating a state in which the locking of the cartridge is released in the camera shown in FIG. 14;

FIG. 22 is a lateral cross-sectional view illustrating the state shown in FIG. 21;

FIG. 23 is a lateral cross-sectional view illustrating a state before recording paper is fed in the state shown in FIG. 19;

FIG. 24 is a lateral cross-sectional view illustrating a state in which recording paper is fed and the cartridge is locked in the camera shown in FIG. 14;

FIG. 25 is a lateral cross-sectional view illustrating a state in which a sheet feeding state of recording paper is detected in a camera including a printer, according to a third embodiment of the present invention;

FIG. 26 is a lateral cross-sectional view illustrating a state in which a locking-release button is locked in the state shown in FIG. 25;

FIG. 27 is a lateral cross-sectional view illustrating a state in which recording paper has passed through a detection member, in the camera shown in FIG. 25;

FIG. 28 is a lateral cross-sectional view illustrating a state in which the locking of the locking-release button is released in the state shown in FIG. 27; and

FIG. 29 is a lateral cross-sectional view illustrating a state in which locking of a cartridge is released by operating the locking-release button, in the camera shown in FIG. 25.

### DETAILED DESCRIPTION OF THE PREFERRED EMBODIMENTS

Preferred embodiments of the present invention will now be described in detail with reference to the drawings.

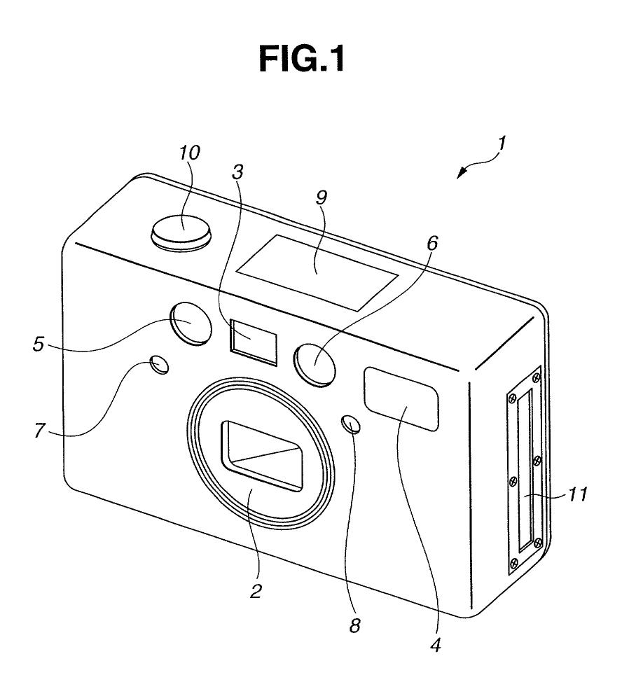

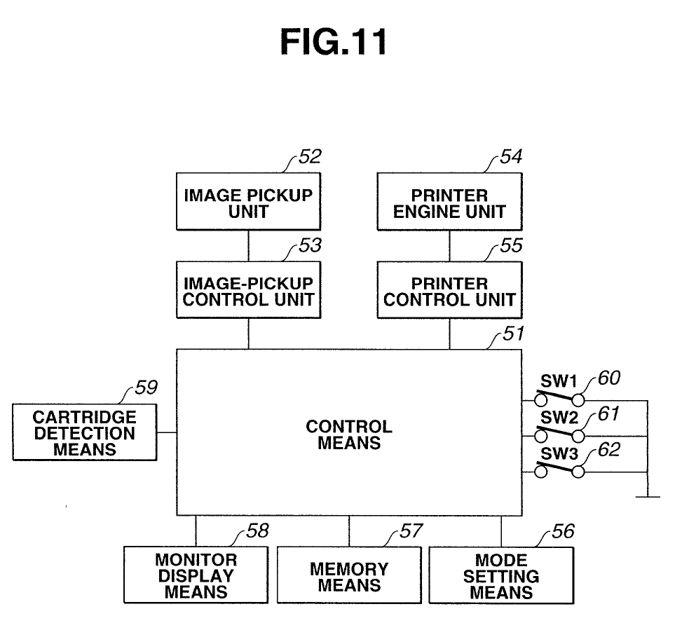

FIGS. 1-13 illustrate a camera including a printer, and a cartridge according to a first embodiment of the present invention. The camera including the printer according to the first embodiment includes a digital camera unit (including an image pickup unit and an image-pickup control unit shown in FIG. 11) for storing an image photographed using a solid-state image pickup device, such as a CCD (charge coupled device) or the like, in a memory, and a printer unit (including a printer engine unit and a printer control unit shown in FIG. 11) for printing/outputting an image stored in the memory on recording paper, for example, according to an ink-jet recording method.

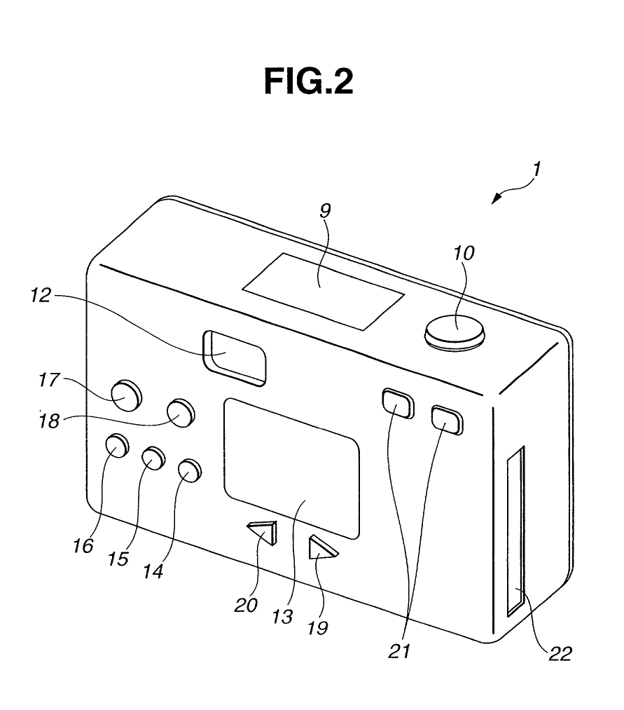

First, the configuration of the camera including the printer will be described with reference to FIGS. 1 and 2. FIG. 1 is a perspective view, as seen from a front right side, of the camera including the printer. FIG. 2 is a perspective view, as seen from a rear right side, of the camera including the printer.

On the front surface of the camera (image pickup apparatus) 1, there are provided a lens-barrel unit 2 including a photographing-lens unit (not shown), a finder objective window 3, a stroboscope 4, an AF (auto-focus) light projecting window 5, an AF light receiving window 6, a remote-control light receiving window 7, and a photometric AE (automatic exposure) window 8. On the upper surface of the camera 1, there are provided a liquid-crystal display panel for information 9, and a release button 10. On the right side (as seen from the front side) of the camera 1, there is provided a discharge-port opening/closing lid 11.

On the rear surface of the camera 1, there are provided a finder eyepiece 12, a liquid-crystal display panel for images 13, a mode switching button 14, a size setting button 15, a number-of-prints setting button 16, a main-switch button 17, a print button 18, an image forwarding button 19, an image return button 20, and a zooming button 21. On the left side (as seen from the front side) of the camera 1, there is provided an insertion-port opening/closing lid 22.

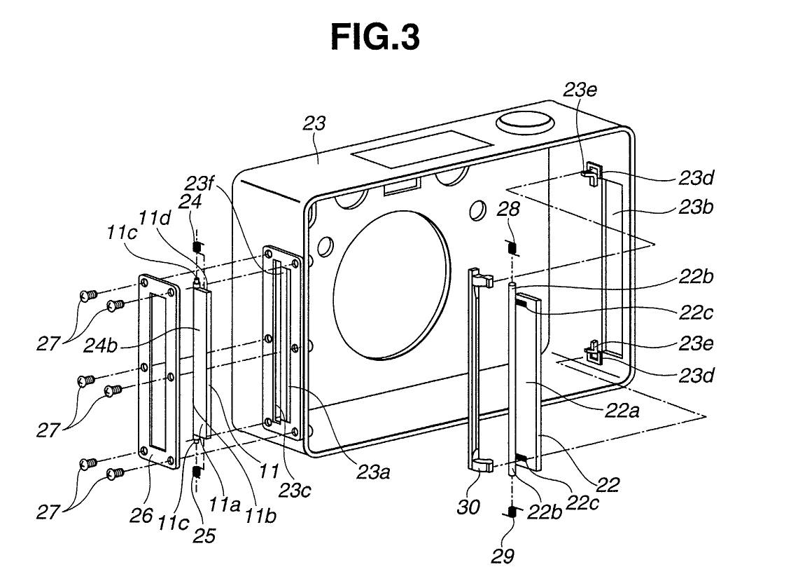

Next, a description will be provided of the configurations of discharge-port opening/closing and insertion-port opening/closing of the camera 1 with reference to FIG. 3. FIG. 3 is an exploded perspective view illustrating the configuration of discharge-port opening/closing and insertion-port opening/closing of the camera 1.

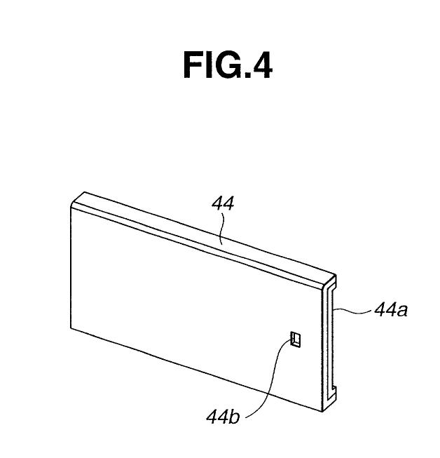

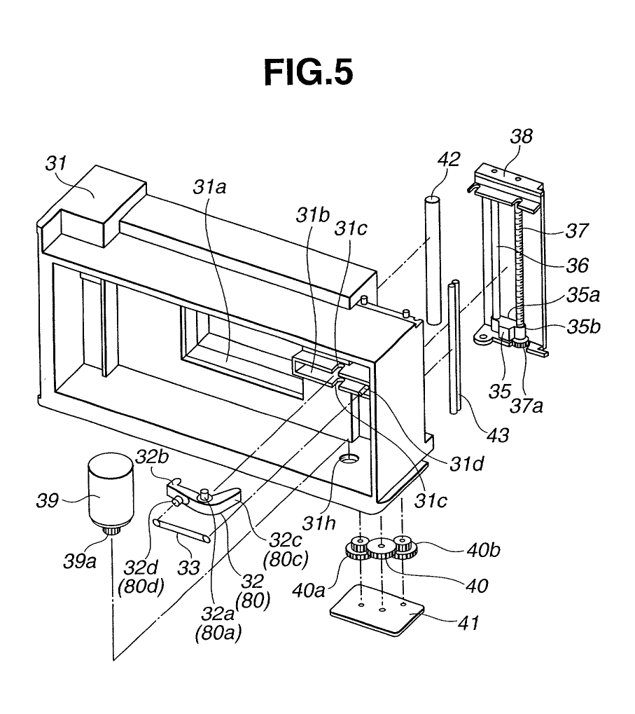

A cover 23 covers a camera main body 31 (an image-pickup-device main body) (see FIG. 5). A rectangular discharge port 23a for discharging recording paper 45 (see FIG. 7) outside of the camera main body 31, and a rectangular insertion port 23b for inserting a cartridge 44 (see FIG. 4) are formed in the cover 23.

First, the configuration of discharge-port opening/closing will be described. The discharge-port opening/closing lid 11 is for opening/closing the discharge port 23a of the cover 23, linked with a sheet feeding operation of the recording paper 45 accommodated within the cartridge 44. The discharge-port opening/closing lid 11 is disposed so that a rectangular flat unit 11a larger than the discharge port 23a of the cover 23 is outside the cover 23, and is at the back side of the printing surface of the recording paper 45 when the discharge-port opening/closing lid 11 opens. A rotating shaft 11b formed at a left-end portion of the flat unit 11a rotatably fits a U-shaped groove 23c formed in the cover 23, and is held on the cover 23 by a pressing plate 26. On the discharge-port opening/closing lid 11, Shafts 11c for holding springs 24 and 25 are formed on upper and lower end portions of the rotating shaft 11b, and holes 11d for fixing one end portions, respectively, of the springs 24 and 25 are formed in upper and lower distal ends of the flat unit 11a.

The springs 24 and 25 urges the discharge-port opening/closing lid 11 so as to cover the discharge port 23a of the cover 23. The springs 24 and 25 are disposed above and below, respectively, the discharge-port opening/closing lid 11, and are supported on the shafts 11c of the discharge-port opening/closing lid 11. One ends of the springs 24 and 25 are fixed in the holes 11d of the discharge-port opening/closing lid 11, and another ends of the springs 24 and 25 contact the pressing plate 26. The pressing plate 26 is fixed on the cover 23 by screws 27, and holds the discharge-port opening/closing lid 11 and the springs 24 and 25 on the cover 23.

Next, the configuration of insertion-port opening/closing will be described. The insertion-port opening/closing lid (first locking means, an opening/closing member) 22 is for opening/closing the insertion port 23b of the cover 23 linked with a mounting/detaching operation of the cartridge 44 with respect to the camera 1. In the insertion-port opening/closing lid 22, a rectangular flat unit 22a larger than the insertion port 23b of the cover 23 is disposed so as to be inside of the cover 23. A rotating shaft 22b extruding from upper and lower end portions of the flat unit 22a rotatably fits in U-shaped grooves 23d formed in the cover 23, and is held on the cover 23 by a pressing plate 30. Recesses 22c for fixing one ends of springs 28 and 29 are formed at upper and lower portions, respectively, of the flat unit 22a.

The springs (first locking means) 28 and 29 urges the insertion-port opening/closing lid 22 so as to cover the insertion port 23b of the cover 23. The springs 28 and 29 are disposed above and below, respectively, the insertion-port opening/closing lid 22, and are supported on the rotating shaft 22b of the insertion-port opening/closing lid 22. One ends of the springs 28 and 29 contact the recesses 22c of the insertion-port opening/closing lid 22, and another ends of the springs 28 and 29 contact recesses 23e formed at the cover 23. The pressing plate 30 is fixed on the cover 23 by screws (not shown), and holds the insertion-port opening/closing lid 22 and the springs 28 and 29 on the cover 23.

Next, a description will be provided of the cartridge 44 of the camera 1 with reference to FIG. 4. FIG. 4 is a perspective view illustrating an external appearance of the cartridge 44.

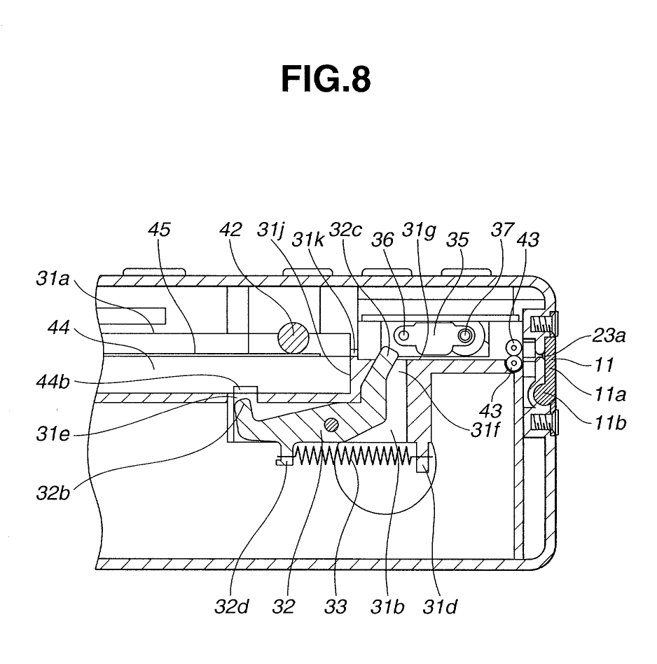

A plurality of sheets of the recording paper 45 (see FIG. 8) and an ink tank (not shown) are accommodated within the cartridge 44. The cartridge 44 can be detachably mounted in a cartridge accommodating chamber 31a (see FIG. 5) formed in the camera main body 31. Ink sufficient enough for printing for the sheets of the recording paper 45 accommodated within the cartridge 44 is filled in the ink tank. A discharging portion 44a for discharging the recording paper 45, and an anchoring hole 44 for accepting an anchoring pawl 32b of a locking lever 32 (see FIG. 5) are formed in the cartridge 44.

Next, a description will be provided of the configuration of cartridge locking, recording-head driving, and sheet feeding of the camera 1 with reference to FIG. 5. FIG. 5 is an exploded perspective view illustrating the configurations of cartridge locking, recording-head driving, and sheet feeding of the camera 1.

First, the configuration of cartridge locking will be described. A locking lever (locking means, second locking means, a rotating member) 32 performs switching between a locking state in which the cartridge 44 loaded within the cartridge accommodating chamber 31a of the camera main body 31 is locked to a sheet feeding position, and a locking-release state in which the cartridge 44 can be taken out, by detecting the sheet feeding state of the recording paper 45. The locking lever 32 locks the cartridge 44 when feeding of the recording paper 45 accommodated within the cartridge 44 is started. The locking lever 32 is disposed within an accommodating unit 31b formed in the camera main body 31. A rotating shaft 32a formed on the locking lever 32 is rotatably supported in a U-shaped slit 31c formed on the camera main body 31.

An anchoring pawl (one end portion) 32b for anchoring the cartridge 44, a detection portion (another end portion) 32c for detecting the sheet feeding state of the recording paper 45 accommodated within the cartridge 44, and a shaft 32d for receiving a spring 33 are formed on the locking lever 32. The anchoring pawl 32b is allowed to enter the cartridge accommodating chamber 31a of the camera main body 31 by being threaded through a hole 31e formed in the camera main body 31 (see FIG. 8). The detection portion 32c is allowed to enter a portion between the cartridge 44 and a recording head 35 (in front of the recording head 35) by being disposed within a running portion 31g (a sheet feeding path) where the recording paper 45 runs, by being threaded through a hole 31f formed in the camera main body 31 (see FIG. 8).

The spring (locking means, second locking means) 33 is urged so as to cause the anchoring pawl 32b of the locking lever 32 to retract from the anchoring hole 44b of the cartridge 44 (in a locking releasing direction). One end of the spring 33 is fixed on the shaft 32d of the locking lever 32, and another end of the spring 33 is fixed on the shaft 31d formed in the camera main body 31.

Next, the configurations of recording-head driving and sheet feeding will be described. The recording head 35 is disposed on the rear surface of the camera main body 31, and prints an image photographed by an image pickup unit 52 (see FIG. 11) on the recording paper 45 by discharging ink onto the recording paper 45. A fitting hole 35a and a screw hole 35b are formed at both sides of the recording head 35. The fitting hole 35a slidably fits with a guide shaft 36. The screw hole 35b is slidably supported on the guide shaft 36 by meshing with a feed screw 37, and reciprocates in a direction orthogonal to the sheet feeding direction (vertical directions).

The guide shaft 36 and the feed screw 37 are supported on a head base plate 38, which is disposed at the back surface of the camera main body 31 and is fixed on the camera main body 31 by screws (not shown). A gear 37a is formed on the feed screw 37, and meshes with a gear 40b of a transmission gear unit 40. According to this meshing, the torque of a motor 39 is transmitted to the feed screw 37. A gear 39a is subjected to press fitting at the distal end of the motor 39, which is fixed on the camera main body 31 by screws (not shown). The gear 39a of the motor 39 meshes with a gear 40a of the transmission gear unit 40 while being threaded through a hole 31h formed in the camera main body 31. According to this meshing, the torque of the motor 39 is transmitted to the transmission gear unit 40.

The transmission gear unit 40 is disposed below the camera main body 31, and is held on the camera main body 31 by a gear pressing plate 41 in a state of being rotatably fitted and supported on respective shafts (not shown) formed in the camera main body 31. By meshing of the gear 40a of the transmission gear unit 40 with the gear 39a of the motor 39, and meshing of the gear 40b with the gear 37a of the feed screw 37, the torque of the motor 39 is transmitted to the feed screw 37. The gear pressing plate 41 is fixed on the camera main body 31 by screws (not shown).

A sheet feeding roller 42 is disposed behind the camera main body 31, and feeds the recording paper 45 accommodated within the cartridge 44 to the recording head 35. The sheet feeding roller 42 is rotatably driven by the motor 39. A conveyance roller 43 is disposed behind the camera main body 31 as the sheet feeding roller 42, and feeds the recording paper 45 fed from the cartridge 44 to the discharging port 23a (see FIG. 3) of the cover 23. The conveyance roller 43 is rotatably driven by the motor 39.

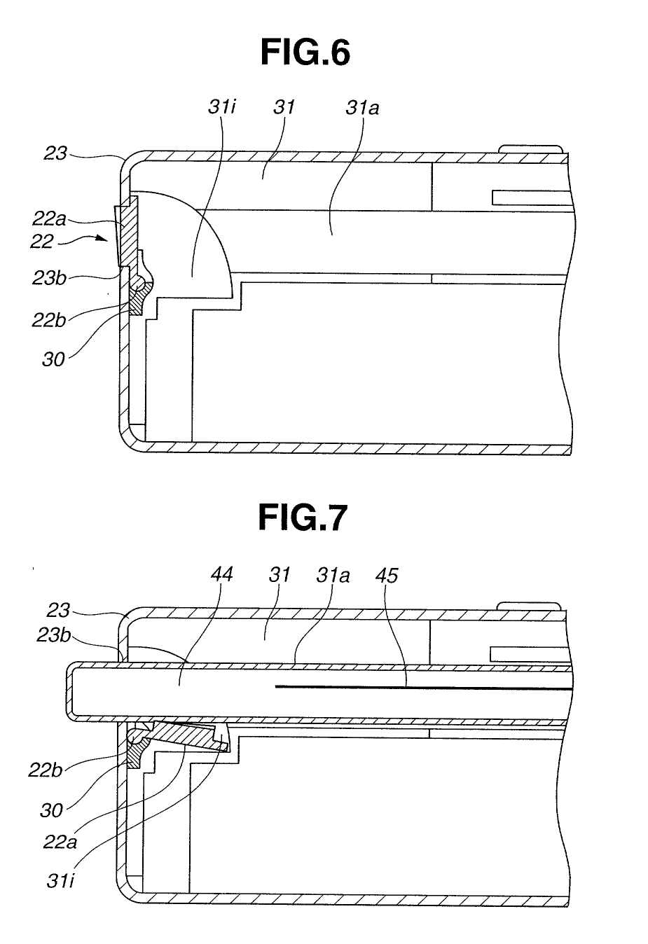

Next, a description will be provided of a cartridge detaching operation with respect to the camera 1 with reference to FIGS. 6-8. FIG. 6 is a lateral cross-sectional view illustrating a state in which the cartridge 44 is taken out of the cartridge accommodating chamber 31a of the camera 1. FIG. 7 is a lateral cross-sectional view illustrating a state in which the cartridge 44 is loaded within the cartridge accommodating chamber 31a of the camera 1. FIG. 8 is a lateral cross-sectional view illustrating a state before the recording paper 45 is fed in the state shown in FIG. 7.

(Cartridge Loading Operation)

From the state shown in FIG. 6, the flat unit 22a of the insertion-port opening/closing lid 22 is pressed, and the insertion-port opening/closing lid 22 is rotated around the rotation shaft 22b in a clockwise direction while charging the springs 28 and 29 (see FIG. 3). According to this rotation, the insertion-port opening/closing lid 22 is accommodated into an opening/closing-lid accommodating unit 31i formed in the camera main body 31, to open the insertion port 23b of the cover 23. As shown in FIG. 7, by further pushing the cartridge 44, the cartridge 44 is loaded into the cartridge accommodating chamber 31a of the camera main body 31, and, as shown in FIG. 8, contacts an end 31j within the cartridge accommodating chamber 31a. According to this contact, the sheet feeding position of the cartridge 44 is determined, and a cartridge loading switch (not shown) fixed in the camera main body 31 is switched on.

(Cartridge Taking-out Operation)

As shown in FIG. 8, until starting a sheet feeding operation of the recording paper 45 (before operating the print button 18), the locking lever 32 is in a state in which the anchoring pawl 32b of the locking lever 32 (see FIG. 5) is retracted from the anchoring hole 44b of the cartridge 44 (a locking-release state) by the spring force of the spring 33, so that the cartridge 44 can be taken out of the cartridge accommodating chamber 31a of the camera main body 31. In this state, if the cartridge 44 is taken out of the insertion port 23b of the cover 23, the insertion-port opening/closing lid 22 accommodated within an opening/closing-lid accommodating unit 31i of the camera main body 31 is rotated around the rotation shaft 22b in a counterclockwise direction by the spring force of the charged springs 28 and 29. According to this rotation, the insertion-port opening/closing lid 22 blocks the insertion port 23b of the cover 23, as shown in FIG. 6.

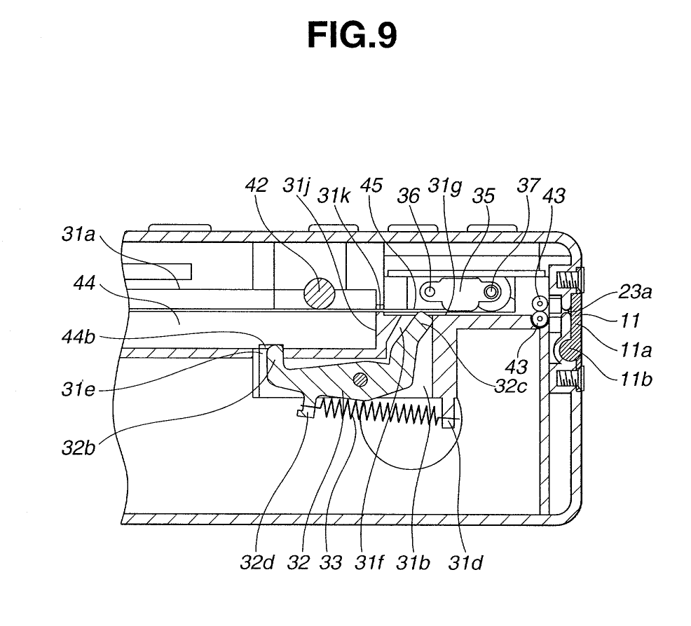

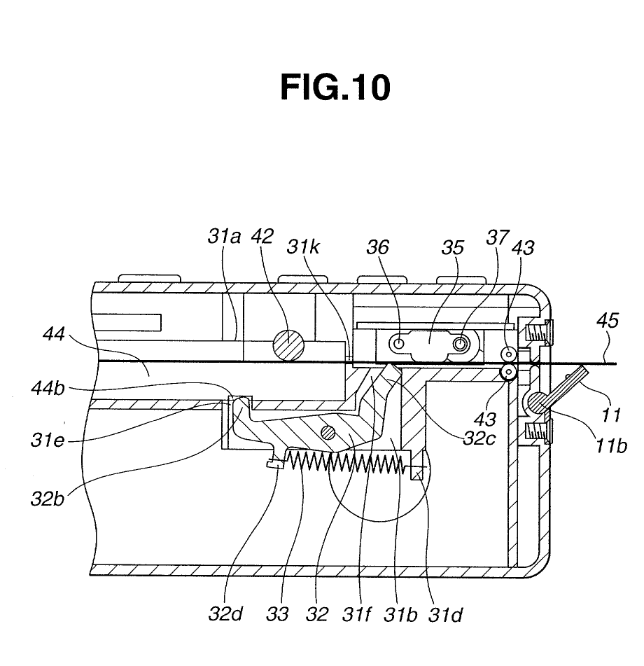

Next, a description will be provided of a cartridge locking operation, a recording-paper discharging operation and a printing operation with reference to FIGS. 9 and 10. FIG. 9 is a lateral cross-sectional view illustrating a state in which the recording paper 45 is fed and the cartridge 44 is locked. FIG. 10 is a lateral cross-sectional view illustrating a state in which the printed recording paper 45 is discharged outside of the cover 23.

When the print button 18 is depressed, a pumping operation for filling ink is performed between an ink tank (not shown) accommodated within the cartridge 44, and the recording head 35. Then, the motor 39 (see FIG. 5) revolves, and the torque of the motor 39 is transmitted to the feed screw 37, the sheet feeding roller 42 and the conveyance roller 43 via the transmission gear unit 40. The sheet feeding roller 42 to which the torque has been transmitted is rotated in a counterclockwise direction. According to this rotation, the recording paper 45 accommodated within the cartridge 44 is discharged from the discharge port 44a of the cartridge 44, and is fed to the recording head 35 after passing through an opening 31k formed in the end 31j of the camera main body 31.

At that time, as shown in FIG. 9, by contact of the recording paper 45 with the detection portion 32c of the locking lever 32 that has entered the running portion 31g of the camera main body 31, before the recording paper 45 passes through the recording head 35, the locking lever 32 is rotated around the rotation shaft 32a in a clockwise direction while charging the spring 33. According to this rotation, the anchoring pawl 32b of the locking lever 32 enters the anchoring hole 44b of the cartridge 44, and the cartridge 44 is locked at a sheet feeding position. As a result, the cartridge 44 cannot be taken out of the cartridge accommodating chamber 31a of the camera main body 31.

Then, the recording paper 45 passes through the recording head 35. At that time, the recording head 35 prints an image photographed by the image pickup unit 52 (see FIG. 11) on the recording paper 45 by discharging ink onto the recording paper 45 while reciprocating in vertical directions along the lead of the feed screw 37. The recording paper 45 on which the image has been printed is fed to the discharge port 23a of the cover 23 by the conveyance roller 43. By contact of the recording paper 45 with the flat unit 11a of the discharge-port opening/closing lid 11, the discharge-port opening/closing lid 11 is rotated around the rotation shaft 11b in a clockwise direction while charging the springs 24 and 25.

According to this rotation, as shown in FIG. 10, the discharge port 23a of the cover 23 (see FIG. 5) is opened, and the recording paper 45 is discharged. When the photographer takes the discharged recording paper 45 out of the camera 1, the recording paper 45 and the discharge-port opening/closing lid 11 assume a non-contact state. Hence, the discharge-port opening/closing lid 11 is rotated around the rotation shaft 11b in a counterclockwise direction by the spring force of the charged springs 24 and 25. According to this rotation, the discharge port 23a of the cover 23 is blocked, as shown in FIG. 8.

Since the recording paper 45 and the detection portion 32c of the locking lever 32 assume a non-contact state, the locking lever 32 is rotated around the rotation shaft 32a in a counterclockwise direction by the spring force of the charged spring 33. According to this rotation, the detection portion 32c of the locking lever 32 enters the running portion 31g of the camera main body 31, and the anchoring pawl 32b of the locking lever 32 thereby retracts from the anchoring hole 44b of the cartridge 44. According to this retraction, the locking of the cartridge 44 is released, so that the cartridge 44 can be taken out of the cartridge accommodating chamber 31a of the camera main body 31.

Next, the functions of the camera 1 will be described with reference to FIG. 11. FIG. 11 is a block diagram illustrating the functions of the camera 1.

The camera 1 includes control means 51 for controlling the entire apparatus, the image pickup unit 52 for photographing an image of an object and outputting an image signal representing the photographed image, an image-pickup control unit 53 for controlling an image-pickup operation of the image pickup unit 52, a printer engine unit 54 for printing image data on the recording paper 45 fed from the cartridge 44, a printer control unit 55 for controlling the printing operation of the printer engine unit 54, mode setting means 56 for setting a photographing mode, a picture-quality mode, a print-output mode or the like, memory means 57 for storing photographed image data, monitor display means for displaying photographed image data or the like, cartridge detection means 59 for detecting the state of loading the cartridge 44, and a plurality of switches 60-62 (hereinafter termed SW1-SW3) for performing various settings and instructions.

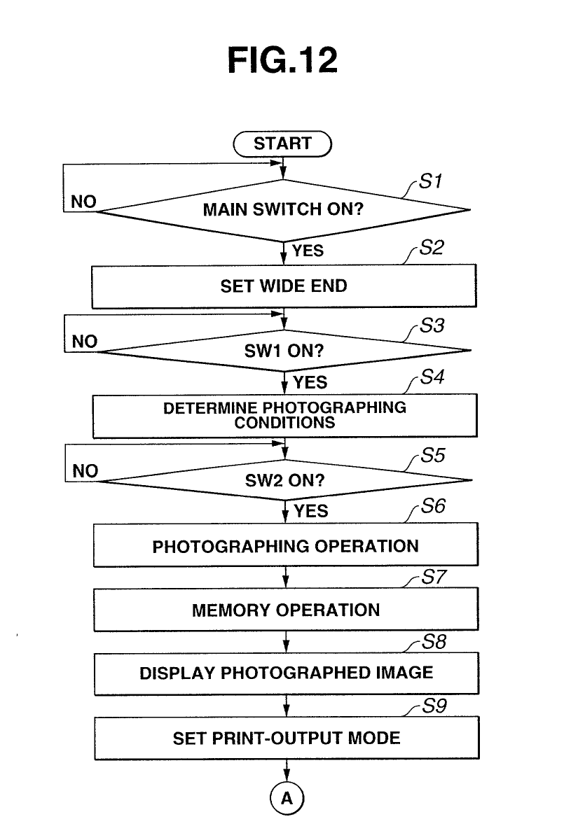

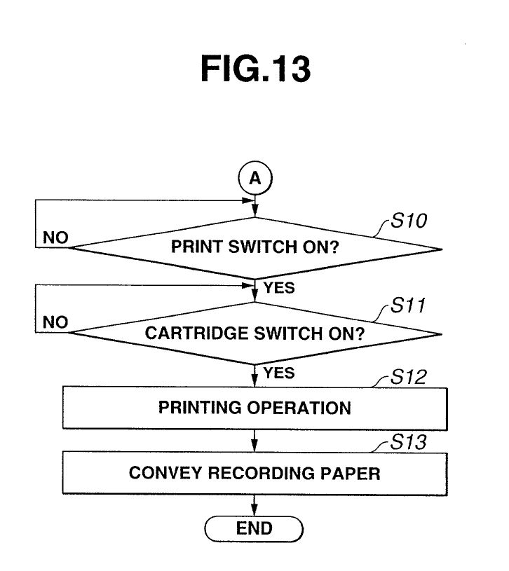

Next, operations of the camera 1 will be described with reference to FIGS. 12 and 13. FIGS. 12 and 13 are flowcharts, each illustrating an operation procedure of the camera 1. Each of these flowcharts is executed based on control of the control means 51.

When the main switch 17 of the camera 1 has been switched on (step S1), electric power is automatically supplied to the entire apparatus. The control means 51 drives the image pickup unit 52 via the image-pickup control unit 53 (step S2). More specifically, the lens-barrel unit 2 is driven and set to a wide end of the photographing position. Thereafter, an operation, such as mode setting by the photographer, or the like, is performed. For example, setting of a photographing mode is performed using the mode setting means 56. In the first embodiment, the camera 1 has a plurality of typical modes, such as a completely automatic photographing mode, a portrait mode, a continuous photographing mode or the like, and a desired photographing mode can be selected by operating the mode switching button 14. When a photographing mode has been selected by operating the mode switching button 14, a signal indicating the selected photographing mode is input to the control means 51, which sets the selected photographing mode.

When the photographer depresses the release button 10 to a first stroke after adjusting the angle of view using the zooming button 21 in a photographing operation, a SW1 signal is input from the switch 60 to the control means 51 (step S3). In response to the input of the SW1 signal, the control means 51 drives the image pickup unit 52 via the image-pickup control unit 53, to determine the value of exposure control in accordance with the amount of light input from the photometric AE window 8, range information using near-infrared radiation projected/received from/by the AF light projecting window 5/AF light receiving window 6, and various conditions necessary for an exposure operation, such as emission/non-emission of the stroboscope 4, and the like (step S4).

When the photographer further depresses the release button 10 in order to execute an actual photographing operation, a SW2 signal from the switch 61 is input to the control means 51 (step S5). The control means 51 performs a series of exposure operations, such as lens driving for focusing, shutter-speed control, diaphragm-aperture control, emission of the stroboscope 4 if necessary, and the like, by driving the image pickup unit 52 via the image-pickup control unit 53 (step S6), and stores information relating to the image photographed by a solid-state image pickup device (not shown) in the memory means 57 (step S7). The control means 51 displays the photographed-image information by driving the monitor display means 58, i.e., the liquid-crystal display panel for images 13 (step S8). A photographing operation is performed by repeating the above-described operations, and photographed image data is stored in the memory means 57.

When the photographer desires a print output, the print-output mode is set via the mode setting means 56 (step S9). In the setting of the print-output mode, setting of a size using the size setting button 15 for switching the size of the area of the image to be printed, and setting of the number of prints using the number-of-prints setting button 16 are performed. By performing retrieval while displaying each image by forwarding or returning image information stored in the memory means 57 using the image forwarding button 19 or the image returning button 20, respectively, image information to be subjected to print output is selected.

When the photographer has depressed the print button 18 (step S10), a SW3 signal is input from the switch 62, i.e., the print button 18, to the control means 51, which shifts to control of a printing operation. The control means 51 determines whether or not the cartridge 44 is loaded in the camera main body 31, based on an output from the cartridge detection means 59, i.e., a cartridge loading switch (step S11), and executes a printing operation by the printer engine unit 54 via the printer control unit 55 if the cartridge 44 is loaded in the camera main body 31 (step S12).

In this printing operation, the printer control unit 55 performs image processing (color correction, binary-coding processing or the like) for a print output, for image information stored in the memory means 57, and outputs image information after the image processing to the printer engine unit 54. The printer engine unit 54 performs printing on the recording paper 45 fed from the cartridge 44. The printed recording paper 45 is conveyed and discharged from the discharge port 23a of the cover 23 (step S13).

As described above, in the camera including the printer according to the first embodiment, by detecting a state of feeding the recording paper 45 accommodated within the cartridge 44, and providing the locking means (the locking lever 32 and the spring 33) for performing switching between the locking state in which the cartridge 44 is locked at a sheet feeding position and the locking releasing state in which the cartridge 44 can be taken out, the cartridge 44 cannot be taken out during a printing operation. As a result, influence on the printing operation and a failure in the printing operation can be prevented.

Furthermore, since the detection portion 32c of the locking lever 32 is disposed so as to enter a portion in front of the recording head 35, the cartridge 44 can be locked before staring a printing operation. As a result, influence on the printing operation and a failure in the printing operation due to a locking operation can be prevented.

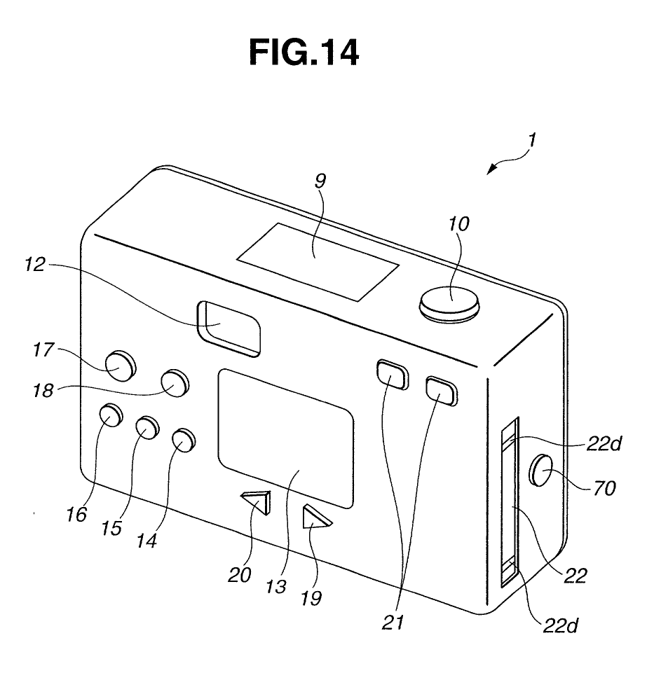

FIGS. 14-24 illustrate a camera including a printer, and a cartridge according to a second embodiment of the present invention. In FIGS. 14-24, the same components as those in the first embodiment are indicated by the same reference numerals. The second embodiment differs from the first embodiment in that first locking means for locking a cartridge 44 when the cartridge 44 is loaded within a cartridge accommodating chamber 31a of a camera main body 31, and locking releasing means for releasing the first locking means when taking out the cartridge 44 are newly provided. In the second embodiment, only configurations and operations which are different from those of the first embodiment will be described. Further description of other configurations will be omitted since they are the same as in the first embodiment.

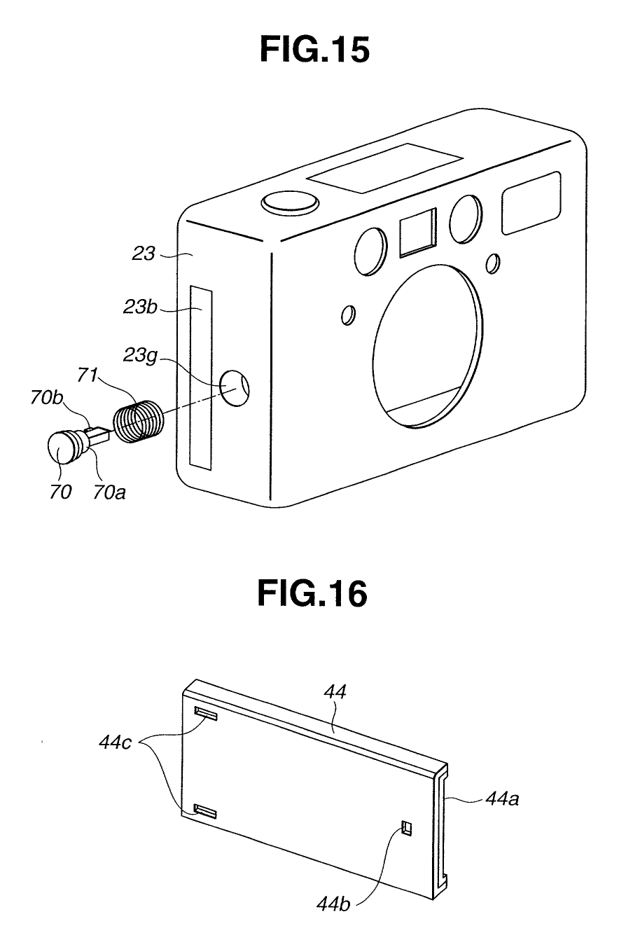

First, the configuration of the camera 1 including the printer will be described with reference to FIGS. 14 and 15. FIG. 14 is a perspective view, as seen from a rear right side, of the camera 1. FIG. 15 is an exploded perspective view illustrating the configuration of a locking-release button of the camera 1.

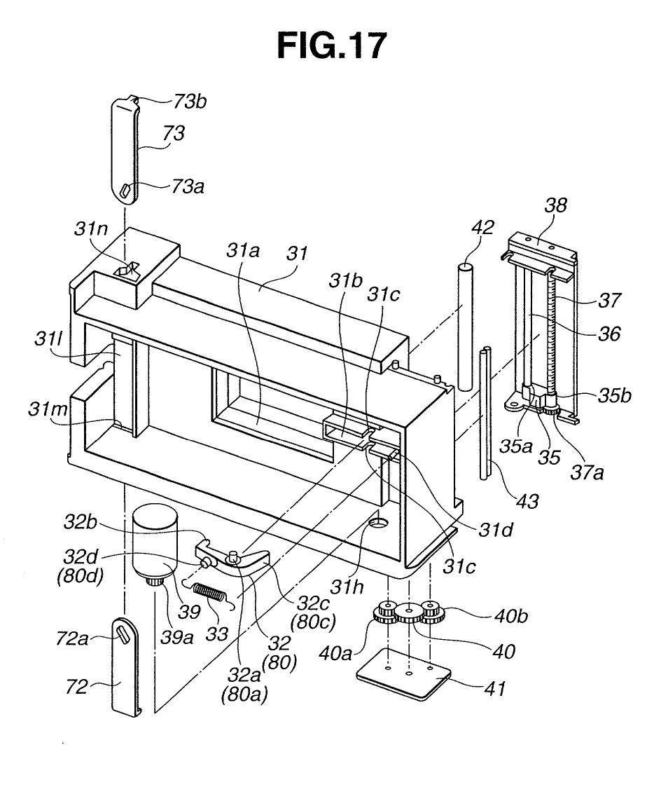

A locking releasing button (locking releasing means, and an operation member) 70 is provided on the left side (as seen from the front side) of the camera 1 at a portion separated from a substantially central portion in the longitudinal direction of an insertion-port opening/closing lid 22. The locking-release button 70 is operated when the photographer takes out the cartridge 44 accommodated within the cartridge accommodating chamber 31a of the camera main body 31. As shown in FIG. 15, the locking releasing button 70 is slidably fitted and supported in a hole 23g formed in a cover 23. A shaft 70a for guiding a spring 71, and a driving shaft 70b for driving locking-release levers 72 and 73 (see FIG. 17) are formed on the locking-release button 70. The spring (locking releasing means) 71 is disposed between the locking-release button 70 and the cover 23.

Next, the cartridge 44 of the camera 1 will be described with reference to FIG. 16. FIG. 16 is a perspective view illustrating an external appearance of the cartridge 44.

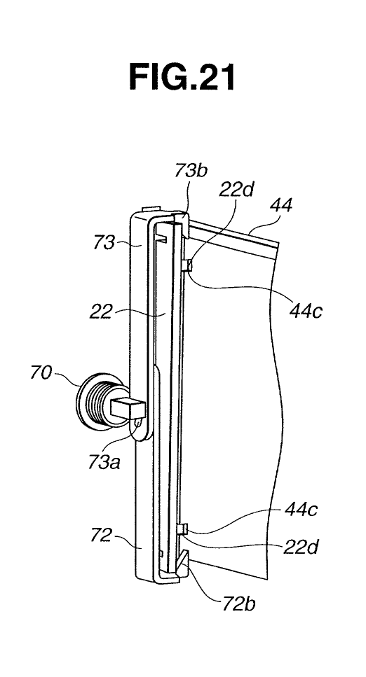

Two anchoring holes 44c where two anchoring pawls 22d (see FIG. 21) integrally formed on upper and lower portions of an insertion-port opening/closing lid (first locking member, a closing member) 22 enter are formed in the cartridge 44. The anchoring pawls 22d of the insertion-port opening/closing lid 22 also operates as guides for preventing a scratch on a plane portion 22a of the insertion-port opening/closing lid 22 caused by the cartridge 44 when loading the cartridge 44.

Next, the configurations of the locking-release levers 72 and 73 will be described with reference to FIG. 17. FIG. 17 is an exploded perspective view illustrating the configurations of the locking-release levers 72 and 73, recording-head driving and sheet feeding.

The locking-release levers (locking-release means, a releasing members) 72 and 73 release the locking state of the cartridge 44 by driving the insertion-port opening/closing lid 22, linked with an operation of the locking-release button 70. The locking-release lever 72 is threaded through a hole 31m formed in the camera main body 31, and is slidably fitted and supported on a guide unit 31l of the camera main body 31. The locking-release lever 73 is threaded through a hole 31n formed in the camera main body 31, and is slidably fitted and supported on a guide member 31l of the camera main body 31.

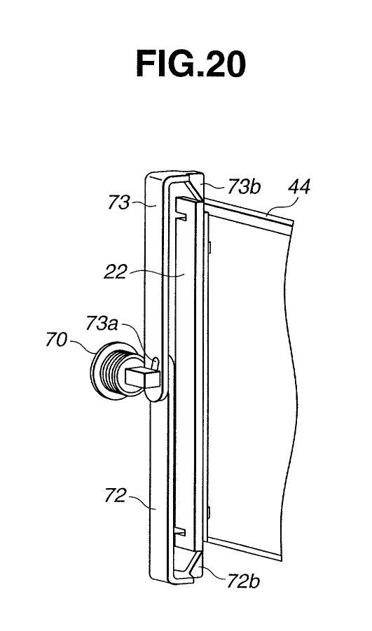

Cam holes 72a and 73a slidably fitted with a driving shaft 70b of the locking-release button 70 are formed in the locking-release levers 72 and 73, respectively. Release portions 72b and 73b (see FIGS. 20 and 21), whose distal ends are inclined, for retracting the anchoring pawl 22d of the insertion-port opening/closing lid 22 from within the anchoring hole 44c of the cartridge 44 by driving the insertion-port opening/closing lid 22 are formed at positions facing the cam hole 72a of the locking-release lever 72 and the cam hole 73a of the locking-release lever 73, respectively.

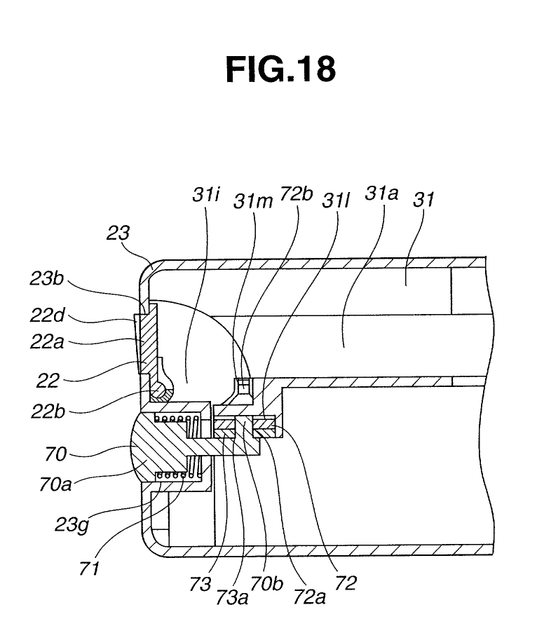

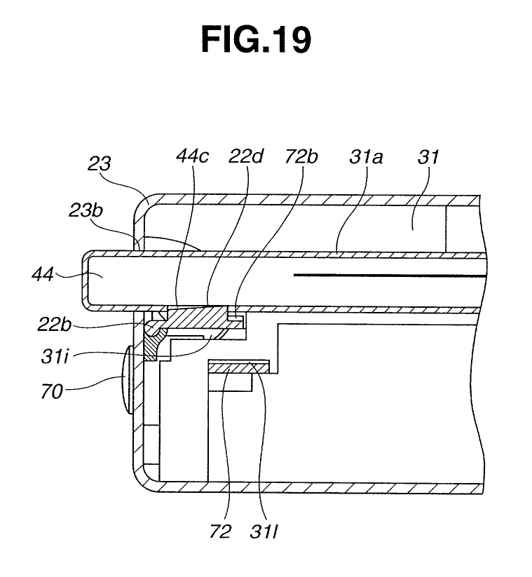

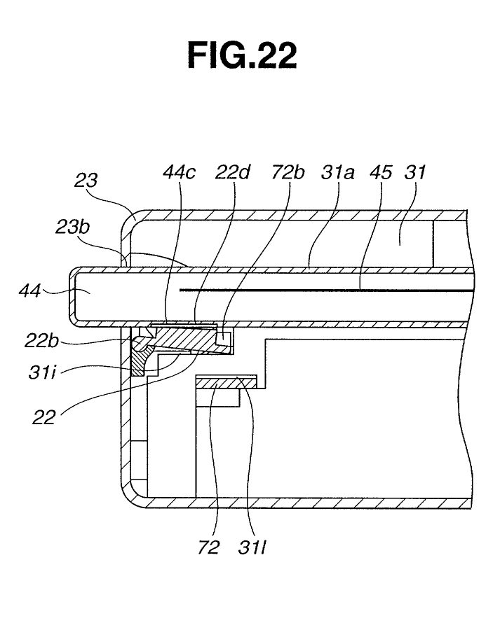

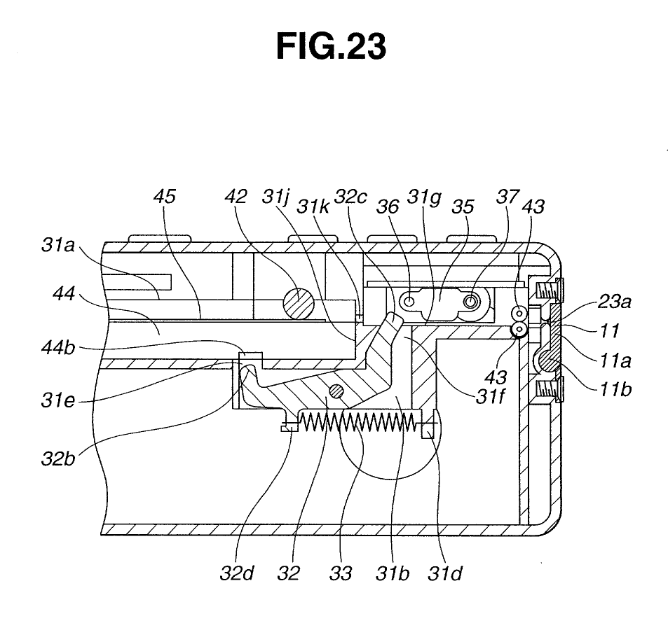

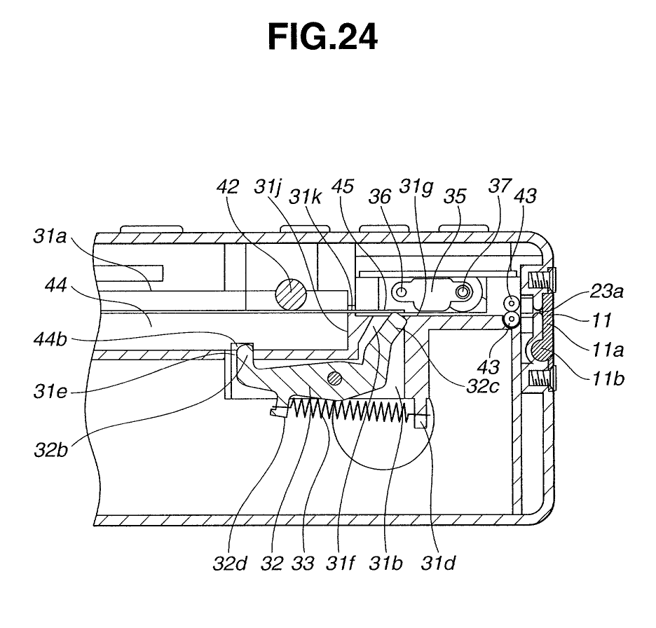

Next, a description will be provided of a cartridge detaching operation and a cartridge locking operation for the camera 1 with reference to FIGS. 18-24. FIG. 18 is a lateral cross-sectional view illustrating a state in which the cartridge 44 is taken out of the cartridge accommodating chamber 31a of the camera 1. FIG. 19 is a lateral cross-sectional view illustrating a state in which the cartridge 44 is loaded within the cartridge accommodating chamber 31a of the camera 1. FIG. 20 is a perspective view illustrating a surrounding portion of the locking-release button 70 indicating a state in which the cartridge 44 is locked. FIG. 21 is a perspective view illustrating the surrounding portion of the locking-release button 70 indicating a state in which locking of the cartridge 44 is released. FIG. 22 is a lateral cross-sectional view illustrating the state shown in FIG. 21. FIG. 23 is a lateral cross-sectional view illustrating a state before recording paper 45 is fed in the state shown in FIG. 19. FIG. 24 is a lateral cross-sectional view illustrating a state in which the recording paper 45 is fed and the cartridge 44 is locked.

(Cartridge Loading Operation)

From the state shown in FIG. 18, the flat unit 22a of the insertion-port opening/closing lid 22 is pressed by the cartridge 44, and the insertion-port opening/closing lid 22 is rotated around a rotation shaft 22b in a clockwise direction while charging springs 28 and 29 (first locking means). According to this rotation, the insertion-port opening/closing lid 22 is accommodated into an opening/closing-lid accommodating unit 31i formed in the camera main body 31, to open an insertion port 23b of the cover 23. As shown in FIG. 23, by further pushing the cartridge 44, the cartridge 44 contacts an end 31j within the cartridge accommodating chamber 31a. According to this contact, the insertion position of the cartridge 44 is determined, and a cartridge loading switch (not shown) fixed in the camera main body 31 is switched on.

At that time, as shown in FIG. 20, the release portions 72b and 73b of the locking releasing levers 72 and 73, respectively, do not contact the insertion-port opening/closing lid 22. Hence, as shown in FIG. 19, the anchoring pawls 22d of the insertion-port opening/closing lid 22s enter the anchoring holes 44c of the cartridge 44. According to this entrance, the cartridge 44 is locked. As a result, the cartridge 44 cannot be taken out of the cartridge accommodating chamber 31a of the camera main body 31.

(Cartridge Taking-out Operation)

As shown in FIG. 23, until starting a sheet feeding operation of the recording paper 45 (until operating a print button 18), a locking lever 32 (second locking lever) is in a state in which an anchoring pawl 32b of the locking lever 32 is retracted from an anchoring hole 44b of the cartridge 44 (a locking-release state) by the spring force of a spring 33 (second locking means), so that the cartridge 44 can be taken out. In this state, if the locking-release button 70 is depressed, then, as shown in FIG. 21, the locking-release lever 72 moves upward along a cam hole 72a (see FIG. 17) from the state shown in FIG. 20, and the locking-release lever 73 moves downward along a cam hole 73a (see FIG. 17).

According to these movements of the locking-release levers 72 and 73, the release portions 72b and 73b of the locking-release levers 72 and 73, respectively, contact the insertion-port opening/closing lid 22. As a result, the insertion-port opening/closing lid 22 is rotated around the rotation shaft 22b in a clockwise direction. According to this rotation, the anchoring pawls 22d of the insertion-port opening/closing lid 22 retract from the anchoring holes 44c of the cartridge 44, to release the locking state of the cartridge 44. As a result, the cartridge 44 can be taken out of the cartridge accommodating chamber 31a of the camera main body 31.

If the print button 18 is depressed, then, as shown in FIG. 24, the recording paper 45 accommodated within the cartridge 44 enters a running portion 31g of the camera main body 31, and contacts a detection portion 32c of the locking lever 32. As a result, the locking lever 32 is rotated around the rotation shaft 32a in a clockwise direction while charging the spring 33. According to this rotation, the anchoring pawl 32b of the locking lever 32 enters the anchoring hole 44b of the cartridge 44 to lock the cartridge 44. Hence, even if the above-described locking-release button 70 is carelessly depressed, the cartridge 44 cannot be taken out of the cartridge accommodating chamber 31a of the camera main body 31.

As described above, in the camera including the printer according to the second embodiment, by providing first locking means (the insertion-port opening/closing lid 22) for locking the cartridge 44 when the cartridge 44 is loaded into the camera main body 31, and second locking means (the locking lever 32 and the spring 33) for locking the cartridge 44 by detecting the sheet feeding state of the recording paper 45 accommodated within the cartridge 44, the cartridge 44 cannot be carelessly taken out. Hence, portability of the camera including the printer can be improved.

Furthermore, since the cartridge 44 cannot be taken out during a printing operation even if the locking-release button 70 is carelessly depressed, influence on the printing operation and a failure in the printing operation can be prevented.

In addition, by operating the first locking means (the insertion-port opening/closing lid 22) by opening/closing the insertion-port opening/closing lid 22, the cartridge 44 loaded within the cartridge accommodating chamber 31a of the camera main body 31 can be locked without increasing the number of components.

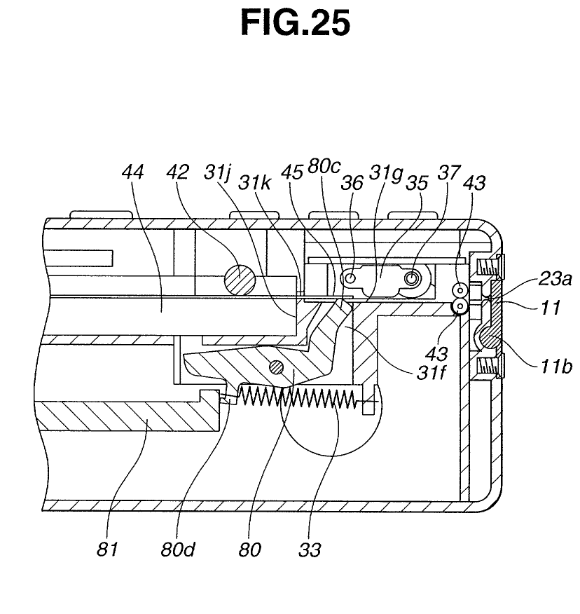

FIGS. 25-30 illustrate a camera including a printer, and a cartridge according to a third embodiment of the present invention. In FIGS. 25-30, the same components as those in the above-described first and second embodiments are indicated by the same reference numerals. The third embodiment differs from the first and second embodiments only in that a locking-release button 70 is locked by detecting a sheet feeding state. In the third embodiment, only operations which are different from those of the first and second embodiments will be described. Further description of other operations will be omitted since they are the same as in the first and second embodiments.

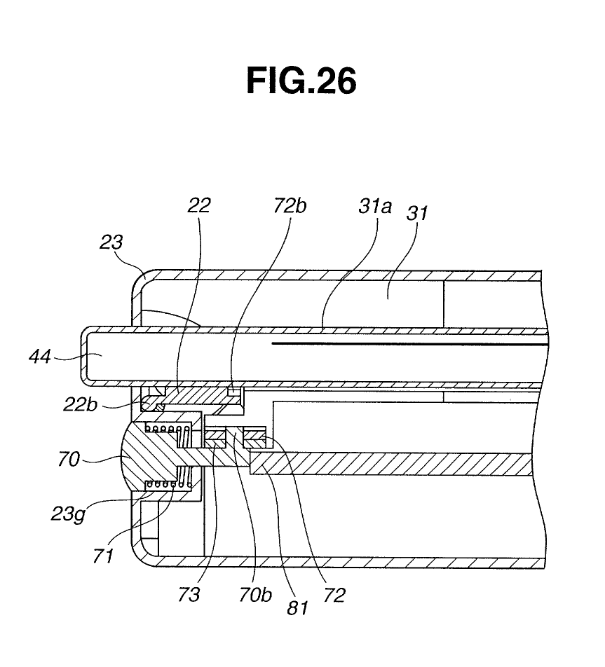

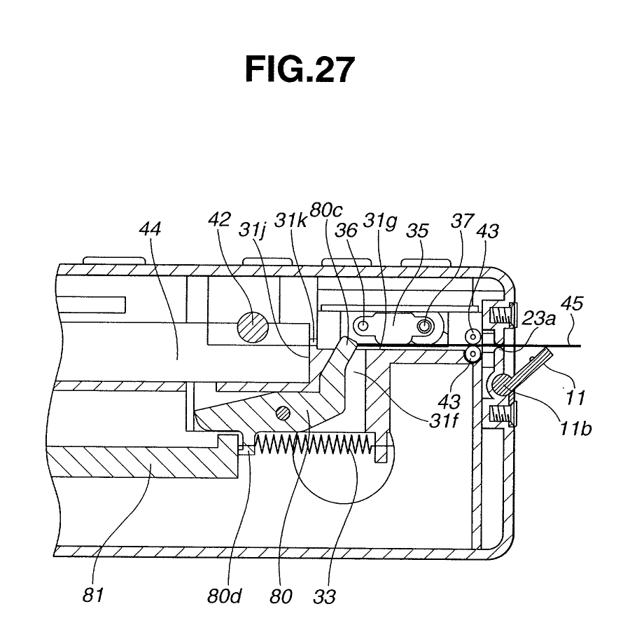

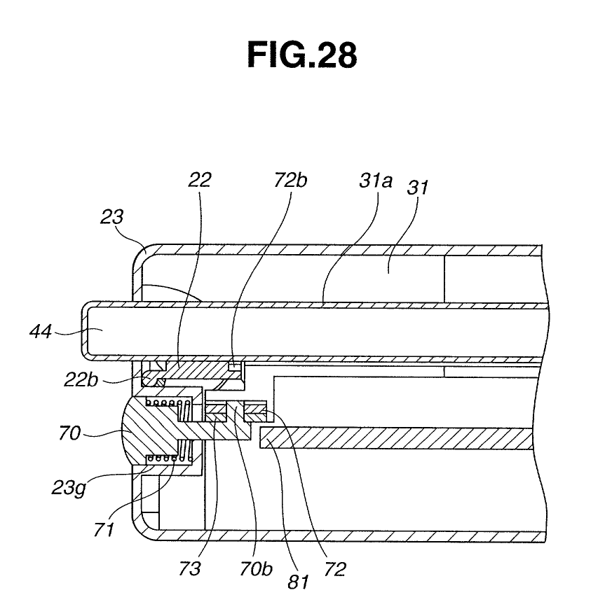

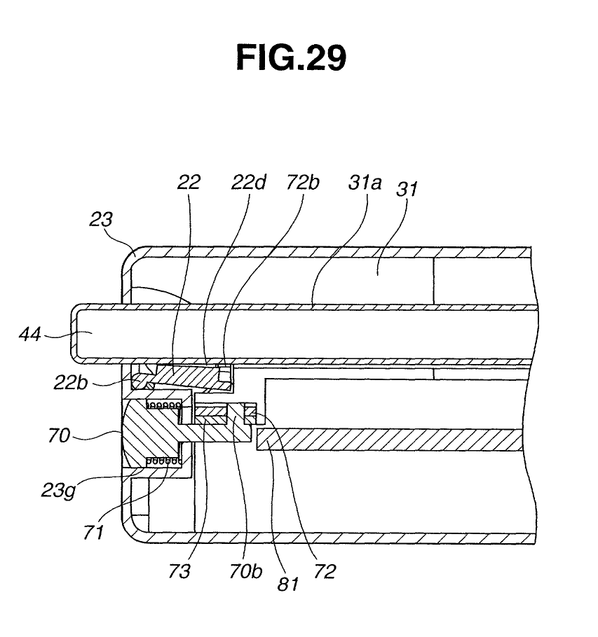

A locking-release-button locking operation, and recording-paper discharging and printing operations will be described with reference to FIGS. 25-30. FIG. 25 is a lateral cross-sectional view illustrating a state in which a recording-paper feeding state in the camera including the printer is detected. FIG. 26 is a lateral cross-sectional view illustrating a state in which the locking-release button 70 is locked in the state shown in FIG. 25. FIG. 27 is a lateral cross-sectional view illustrating a state in which recording paper passes through a detection member. FIG. 28 is a lateral cross-sectional view illustrating a state in which the locking of the locking-release button 70 is released in the state shown in FIG. 27. FIG. 29 is a lateral cross-sectional view illustrating a state in which locking of a cartridge is released by operating the locking-release button 70.

When a print button 18 is depressed, a pumping operation for filling ink is performed between an ink tank (not shown) accommodated within a cartridge 44, and a recording head 35. Then, a motor 39 revolves, and the torque of the motor 39 is transmitted to a feed screw 37, a sheet feeding roller 42 and a conveyance roller 43 via a transmission gear unit 40. The sheet feeding roller 42 to which the torque has been transmitted is rotated in a counterclockwise direction. According to this rotation, the recording paper 45 accommodated within the cartridge 44 is discharged from a discharge port 44a of the cartridge 44, and is fed to the recording head 35 after passing through an opening 31k formed in an end 31j of a camera main body 31.

At that time, as shown in FIG. 25, by contact of the recording paper 45 with a detection portion 80c of a detection lever 80 (second locking means, a rotating member) that has entered a running portion 31g of the camera main body 31, before the recording paper 45 passes through the recording head 35, the detection lever 80 is rotated around a rotation shaft 80a (see FIG. 17) in a clockwise direction while charging a spring 33 (second locking means). A locking lever 81 (second locking means, a locking member) 81 is pushed by a shaft 80d of the detection lever 80, and is moved leftward. According to this movement, as shown in FIG. 26, the locking lever 81 enters a moving range of the locking-release button 70 As a result, the locking-release button 70 is locked and therefore cannot be operated.

Then, the recording paper 45 passes through the recording head 35. At that time, the recording head 35 prints an image photographed by an image pickup unit 52 on the recording paper 45 by discharging ink onto the recording paper 45 while reciprocating in vertical directions along the lead of a feed screw 37. The recording paper 45 on which the image has been printed is fed to a discharge port 23a of a cover 23 by the conveyance roller 43. By contact of the recording paper 45 with a flat unit 11a of a discharging-port opening/closing lid 11, the discharging-port opening/closing lid 11 is rotated around a rotation shaft 11b in a clockwise direction while charging springs 24 and 25. According to this rotation, the discharge port 23a of the cover 23 is opened, and the recording paper 45 is discharged.

According to this discharge operation, since the recording paper 45 and the detection portion 80c of the detection lever 80 assume a non-contact state after the recording paper 45 has passed through the detection portion 80c of the detection lever 80, the detection lever 80 is rotated around a rotation shaft 80a (see FIG. 17) in a counterclockwise direction by the spring force of the charged spring 33, and, as shown in FIG. 27, the detection portion 80c of the detection lever 80 enters the running portion 31g of the camera main body 31. The locking lever 81 which has been pushed by the detection lever 80 moves rightward following the rotation of the detection lever 80.

According to this movement, as shown in FIG. 28, the locking lever 81 entering a moving range of the locking-release button 70 retracts, so that the locking-release button 70 can be operated. By depressing the locking-release button 70, release units 72b and 73b of locking-release levers 72 and 73, respectively, contact an insertion-port opening/closing lid 22, which is thereby rotated around a rotation shaft 22b in a clockwise direction. According to this rotation, as shown in FIG. 29, an anchoring pawl 22d of the insertion-port opening/closing lid 22 retracts from an anchoring hole 44c of the cartridge 44, to release the locking state of the cartridge 44. Accordingly, the cartridge 44 can be taken out of a cartridge accommodating chamber 31a of the camera main body 31.

As described above, in the camera including the printer according to the third embodiment, by providing second locking means (the spring 33, the detection lever 80 and the locking lever 81) for performing switching between a locking state in which the locking-release lever 70 cannot be operated, and a locking-release state in which the locking-release lever 70 can be operated, by detecting the sheet feeding state of the recording paper 45 accommodated within the cartridge 44, the cartridge 44 cannot be taken out during a printing operation. As a result, influence on the printing operation and a failure in the printing operation can be prevented.

Furthermore, since the detection portion 80c of the detection lever 80 is disposed so as to enter a portion in front of the recording head 35, the locking-release button 70 can be locked before staring a printing operation. As a result, influence on the printing operation and a failure in the printing operation due to a locking operation can be prevented.

Although in the first through third embodiments of the present invention, the case of adopting an ink-jet recording method as the recording method of the printer unit of the camera including the printer has been illustrated, the present invention is not limited to the ink-jet recording method. For example, any other recording method, such as a thermal recording method, a thermal transfer recording method or the like, may also be adopted.

Although in the first through third embodiments of the present invention, the case of the camera including the printer has been illustrated, the present invention is not limited to the camera including the printer. For example, the present invention may also be applied to a system including a camera including a printer, a portable information terminal, and the like.

Although in the above-described embodiments, recording paper is used as a recording medium on which printing is performed, the present invention may also be applied to any other appropriate recording medium.

The present invention may be applied to a case in which the entirety or a part of the configuration of a claim or an embodiment constitutes a single apparatus, or is combined with another apparatus, or constitutes a component constituting an apparatus.

The present invention may be applied to each type of camera, such as an electronic camera for photographing a still image or a moving image using an image pickup device, a camera using a silver-halide film, a single-lens reflex camera, a lens shutter camera, a monitor camera or the like, an image pickup apparatus, an optical apparatus or an apparatus other than a camera, an apparatus applied to a camera, or an image pickup apparatus, an optical apparatus or an apparatus other than a camera, or a component constituting each of the above-described apparatuses.

The individual components shown in outline or designated by blocks in the drawings are all well known in the image pickup apparatus, cartridge locking apparatus and cartridge locking method arts and their specific construction and operation are not critical to the operation or the best mode for carrying out the invention.

While the present invention has been described with respect to what are presently considered to be the preferred embodiments, it is to be understood that the invention is not limited to the disclosed embodiments. To the contrary, the present invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An image pickup apparatus having a function for printing a sensed image, said apparatus comprising:
a mounting unit that mounts a cartridge accommodating a recording medium for printing; and
a locking device that locks the cartridge mounted in said mounting unit so as not to be detached, in response to a state in which a printing operation is being performed.

2. An image pickup apparatus according to claim 1, wherein the recording medium includes recording paper.

3. An image pickup apparatus according to claim 2, wherein said locking device comprises a detection unit detecting that a printing operation is being performed, based on a sheet feeding state of the recording paper.

4. An image pickup apparatus according to claim 1, further comprising:
a printing unit for printing on the recording medium.

5. An image pickup apparatus according to claim 1, wherein said locking device comprises a first locking unit that locks the cartridge mounted in said mounting unit so as not be detached whether or not a printing operation is being performed, and a second locking unit that locks the cartridge mounted in said mounting unit so as not be detached when a printing operation is being performed.

6. An image pickup apparatus according to claim 5, wherein said locking device further comprises a locking releasing unit that releases the locking of said first locking unit, and wherein said second locking unit invalidates a locking releasing function of said locking releasing unit in response to a state in which a printing operation is being performed.

7. A cartridge locking method for an image pickup apparatus having a function for printing a sensed image, said method comprising the step of:
locking a cartridge, accommodating a recording medium for printing, mounted in a mounting unit for mounting the cartridge, so as not to be detached, in response to a state in which a printing operation is being performed.

8. A cartridge locking apparatus comprising:
a mounting unit that mounts a cartridge accommodating a recording medium for printing; and
a locking device that locks the cartridge mounted in said mounting unit so as not to be detached, in response to a state in which a printing operation is being performed.

9. A cartridge locking apparatus according to claim 8, wherein the recording medium includes recording paper.

10. A cartridge locking apparatus according to claim 9, wherein said locking device comprises a detection unit detecting that a printing operation is being performed, based on a sheet feeding state of the recording paper.

11. A cartridge locking apparatus according to claim 8, wherein said locking device comprises a first locking unit that locks the cartridge mounted in said mounting unit so as not be detached whether or not a printing operation is being performed, and a second locking unit that locks the cartridge mounted in said mounting unit so as not be detached in response to a state in which a printing operation is being performed.

12. A cartridge locking apparatus according to claim 11, wherein said locking device further comprises a locking releasing unit for releasing the locking of said first locking unit, and wherein said second locking unit invalidates a locking releasing function of said locking releasing unit when a printing operation is being performed.

13. A cartridge locking method comprising the step of:
locking a cartridge, accommodating a recording medium for printing, mounted in a mounting unit for mounting the cartridge, so as not to be detached in response to a state in which a printing operation is being performed.
